(19) United States
(12) Patent Application Publication
(10) Pub. No.: US 2004/0229197 A1
(43) Pub. Date: Nov. 18, 2004

(54) A Method to Increase Productivity of Students Being Trained in Emerging Technologies and to Increase the Return on Investment for Training

(76) Inventor: Tim Hatton, Jamestown, OH (US)

Correspondence Address: Tim Hattton, 4802 Bordeaux Lane, Mason, OH, 45040, US

(21) Appl. No.: 10/249,854

(22) Filed: May 13, 2003

(51) Int. Cl. G09B 19/00; G09B 25/00

(52) U.S. Cl. 434/219; 705/15; 434/362

(57) ABSTRACT

A method to eliminate the inefficiencies of the leture/lab methodology of providing training by specifically designing training according to the business goals of the student's employer and for developing a customized learning plan to provide training while simultaneously meeting those business goals by performing the training using a combination of lectures, hands-on labs designed to advance the business goal, mentoring and support.

### BRIEF SUMMARY OF THE INVENTION

A common problem faced by companies who employ technology aware workers is the necessity of constantly training those employees in newly emerging technologies. Among such companies, it is common practice to provide such training in the form of one week, instructor led courses that take the form of lectures aided by presentation slides and labs to provide hands-on exposure to the new technology.

The foregoing method of providing training is very inefficient in actual use. Material, consisting of printed text, overhead slides, online text and hands-on lab instructions must be designed in a generic manner in order to maintain maximum flexibility of delivery. This type of generic training reduces the amount of retention and application of the training to the students' actual work environment. This results in an extra period of on he job learning being required after completion of the formal training. Students taking this type of training at the behest of an employer must schedule time away from the workplace, reducing their productivity even further. These inefficiencies in delivery reduce the effectiveness of the training and, consequently, the return on investment for dollars spent providing the training.

The instant invention, Context Based Training, eliminates all of the inefficiencies of the leture/lab methodology by providing training that is specifically designed according to the business goals of the student's employer. Each course begins with an analysis of the specific reasons why the training is being provided (the business goal) as well as the current knowledge level of each attending student. From this analysis, a custom training program is designed that teaches the required subject matter within the context of the business goal. Once designed, the course may then be delivered as a combination of lectures, hands-on labs, mentoring and support from the instructor, who becomes a de-facto member of the project team for the duration of the training. Rather than being provided in one week, training provided according to the Context Based methodology will typically be of more than a single week's duration. The combination of the design and delivery is what allows for a greater transfer of knowledge from instructor to student as well as increasing the productivity of the students receiving training and the return on investment for the dollars spent on the training.

The primary value to both students and employers who are paying for training is economic in that the training efficiently allows business goals to be accomplished while training is taking place.

The instant invention comprises the process of analyzing the business goals of the student or employer, analyzing the current knowledge level of the student, designing a custom learning plan that teaches within the context of the business goal desired to be achieved, designing all supporting materials necessary to accomplish the learning plan and delivering the training using a combination of lectures, labs, mentoring and support.

### DETAILED DESCRIPTION OF THE INVENTION

The Context Based Training process begins with a detailed analyis of the business goal that is required to be achieved by the training. The process consists of a series of meetings held between the instructor, the students and the students supervisors during which the instructor becomes aware of the business goal (what is required of the students after the training has been accomplished). The business goal may be a well defined, specific project, or it may merely be a level of knowledge that enables the students to perform some set of post training tasks. The instructor elicits information regarding both the technology that will be the topic of the training, the reasons why the technology has been chosen, whether a specific use (project) must result from the use of the technology and, if a specific project must result, all specifications and requirements related to that project. The instructor uses this information to determine exactly what topics and sub-topics must make up the learning plan, ensuring that the students will be taught the exact concepts they require to succeed.

Once an understanding of the requirments has been gathered, the instructor examines the level of knowledge of each student who will participate in the training. This examination is designed to determine the current state of the student's understanding of the subject matter of the training. This allows the instructor to prune the range of sub-topics in the learning plan to eliminate those which are not required since they are already within the range of the students' capabilities. The learning plan is further refined by setting alternative start dates for students whose knowledge is such that fundamental topics early in the learning plan are not necessary.

After the learning plan has been developed that identifies the specific topics and sub-topics to be included in the training, the instructor begins development of the customized training material. This material will consist of presentation slides to assist in classroom lectures, white papers and hands-on assignments. Where possible, each hands on assignment is specifically designed to further the identified business goal that is driving the training engagement. The timeline for delivery is then developed, in consultation with the students and their managers or employers.

The training is then delivered, beginning in the classroom and continuing with work by the students in furtherance of the business goal. The learning plan guides all aspects of delivery. After the classroom portion of the training has been delivered, the delivery focuses on mentoring and problem solving until the students have sufficient knowledge of the subject matter to function in the work environment without assistance.

1. A method of increasing productivity for students being trained in emerging technologies by customizing the training within the context of a defined business goal.

2. A method according to claim number one whereby the requirements for the custom training are gathered in a seried of meeting with the students and/or the students employer or supervisor.

3. A method according to claim number one whereby the requirements are converted to a customized learning plan that provides for both training and the achievement of the specified business goal simultaneously.

4. A method according to claim one whereby the learning plan is delivered using any combination of classroom presentation, hands-on labs, mentoring and support.

5. A method according to claim number four whereby the hands-on labs are designed to further the defined business goal.
